(19) United States
(12) Patent Application Publication
(10) Pub. No.: US 2011/0150264 A1
(43) Pub. Date: Jun. 23, 2011

(54) SPEAKER MAGNETIC CIRCUIT, SPEAKER DEVICE, AND METHOD OF MANUFACTURING SPEAKER MAGNETIC CIRCUIT

(75) Inventor: Shinsuke Konuma, Yamagata (JP)

(73) Assignees: PIONEER CORPORATION, Tokyo (JP); TOHOKU PIONEER CORPORATION, Yamagata (JP)

(21) Appl. No.: 12/675,079

(22) PCT Filed: Sep. 12, 2007
(86) PCT No.: PCT/JP2007/067752

§ 371 Date: Feb. 24, 2010

(51) Int. Cl. H04R 1/00; H04R 31/00

(52) U.S. Cl. 381/398; 381/412; 29/594

(57) ABSTRACT

The present invention is to provide a speaker magnetic circuit which, even if small in its thickness, can reduce an occurrence of magnetic flux leakage so as to obtain a sufficient magnetic flux density in a magnetic gap, particularly in a position where a voice coil is supported. The speaker magnetic circuit (11) comprises a yoke (12) and a magnet group (13). The magnet group (13) comprises outer magnets (21-24) and inner magnets (25-28). The outer magnets (21-24) and the inner magnets (25-28) are magnetized in an oblique direction with respect to their thickness direction.

### FIELD OF THE INVENTION

The present invention relates particularly to a speaker magnetic circuit suitable for use in a thin-type speaker device mounted in a portable electronic device such as a cellular phone, a portable radio set or a PDA (Personal Digital Assistants). This invention also relates to a speaker device including the speaker magnetic circuit, and a method of manufacturing the speaker magnetic circuit.

### TECHNICAL BACKGROUND

A portable electronic device such as a cellular phone, a portable radio set, or a PDA is required to be compact in size and small in thickness in order to be portable. Therefore, a speaker device used in such a portable electronic device is also needed to have a compact size and a small thickness. To meet the requirement of having a compact size and a small thickness for the above-mentioned speaker device, it is usually considered necessary to reduce the thickness of a speaker magnetic circuit containing magnet and yoke. In order to reduce the thickness of a speaker magnetic circuit, what is required is for example to utilize a radially magnetized magnet.

A conventional speaker magnetic circuit of the above-mentioned type can have for example the following structure. Namely, as shown in FIG. 1, the conventional speaker magnetic circuit contains a yoke 1 having a generally tabular cross-sectional shape. A cylindrical magnet 2 is arranged at the central portion of the yoke 1, and an annular magnet 3 is arranged around the cylindrical magnet 2. In addition, a top plate 4 is fixed on the cylindrical magnet 2, and an top plate 5 is fixed on the annular magnet 3. A magnetic gap 6 is formed between the top plate 4 and the top plate 5 (e.g., patent document 1).

Patent document 1: Japanese Utility Model Publication No. 1983-599 (utility model, claim 1, FIG. 2, etc.)

### Problem(s) to be Solved by the Invention

In the conventional speaker magnetic circuit described above, the cylindrical magnet 2 and the annular magnet 3 are magnetized in the vertical direction shown in FIG. 1, i.e., in a direction perpendicular to the yoke 1. In other words, these magnets are magnetized in a direction parallel to the oscillation direction of a voice coil (not shown) inserted into the magnetic gap 6. In such a conventional speaker magnetic circuit, if it is required to increase the magnetic flux density in the magnetic gap 6, the top plate 5 can be removed and the thickness of the cylindrical magnet 2 can be increased by an extent substantially equal to the thickness of the top plate 5. This, however, will cause the magnetic flux to flow from the top plate 4 to the yoke 1 (i.e. causing a leakage of magnetic flux), resulting in a decrease of the magnetic flux density in the magnetic gap 6 formed between the cylindrical magnet 2 and the annular magnet 3, rendering it impossible to ensure a sufficient magnetic flux density in the magnetic gap 6.

Besides, in the speaker magnetic circuit described above, since the peak of the magnetic flux density is in the side of the yoke 1, it is difficult to ensure a sufficient magnetic flux density at a position where the voice coil is mounted. On the other hand, if the voice coil is arranged at a position where the magnetic flux density is maximum, it will be difficult to ensure a sufficient vibration amplitude of the voice coil. As a result, when a speaker device is fabricated by reducing the thickness of a conventional speaker magnetic circuit, it is difficult to ensure a high sensitivity for the speaker device.

In view of the problems discussed above, it is an object of the present invention to provide a speaker magnetic circuit, a speaker device, and method of manufacturing a speaker magnetic circuit

### Means of Solving the Problems

In order to achieve the above object, the present invention has at least the following constitutions recited in the below-mentioned independent claims.

A speaker magnetic circuit of the present invention, as recited in claim 1, comprises magnets and yoke, with the magnet magnetized in an oblique direction with respect to its thickness direction.

A speaker device of the present invention, as recited in claim 12, comprises a frame, a diaphragm, and a magnetic circuit. The magnetic circuit includes a magnet and a yoke. The magnet is magnetized in an oblique direction with respect to its thickness direction.

A method of manufacturing a speaker magnetic circuit of the present invention, as recited in claim 16, comprises a magnet magnetizing step of applying a magnetic field in an oblique direction with respect to the thickness direction of a magnet

### BRIEF DESCRIPTION OF THE DRAWINGS

FIG. 1 is a cross sectional view showing the structure of a conventional speaker magnetic circuit.

FIG. 2 provides schematic views showing the structure of a speaker magnetic circuit according to embodiment 1 of the present invention, wherein FIG. 2(a) is a plan view and FIG. 2(b) is a sectional view taken along a line A-A in FIG. 2(a).

FIG. 3 provides schematic sectional views showing the structure of a speaker device containing the speaker magnetic circuit shown in FIG. 2, wherein FIG. 3(a) shows an example in which the longitudinal sectional view of a diaphragm is generally conical (cone-shaped) and FIG. 3(b) shows an example in which the diaphragm is generally tabular.

FIG. 4 is a graph showing a magnetic flux density distribution with respect to distances from the upper surface of a bottom portion of a yoke contained in the speaker device of FIG. 3.

FIG. 5 is a schematic sectional view showing a first example of the structure of a speaker magnetic circuit according to embodiment 2 of the present invention.

FIG. 6 is a schematic sectional view showing a second example of the structure of the speaker magnetic circuit according to embodiment 2 of the present invention.

FIG. 7 is a schematic sectional view showing the structure of a speaker magnetic circuit according to embodiment 3 of the present invention.

FIG. 8 is a schematic sectional view showing the structure of a speaker magnetic circuit according to embodiment 4 of the present invention.

FIG. 9 is a schematic sectional view showing the structure of a speaker magnetic circuit according to embodiment 5 of the present invention.

FIG. 10 is a schematic sectional view showing the structure of a speaker magnetic circuit according to embodiment 6 of the present invention.

FIG. 11 is a schematic sectional view showing the structure of a speaker magnetic circuit according to embodiment 7 of the present invention, wherein FIG. 11(a) is a plane view and FIG. 11(b) is a sectional view taken along a line A-A in FIG. 11(a).

FIG. 12 is a schematic sectional view showing the structure of a speaker magnetic circuit according to embodiment 8 of the present invention.

FIG. 13 is a schematic sectional view showing the structure of a speaker magnetic circuit according to embodiment 9 of the present invention.

FIG. 14 is a schematic sectional view showing the structure of a speaker magnetic circuit according to embodiment 10 of the present invention.

FIG. 15 is a schematic sectional view showing the structure of a speaker magnetic circuit according to embodiment 11 of the present invention.

FIG. 16 provides schematic views showing the structure of a speaker magnetic circuit according to embodiment 12 of the present invention, wherein FIG. 16(a) is a plane view and FIG. 16(b) is a sectional view taken along a line A-A in FIG. 16(a)

FIG. 17 provides conceptual views showing a method of manufacturing of the speaker magnetic circuit of embodiment 13 of the present invention.

FIG. 18 is a schematic view showing the structure of a magnetizing device used in the method of manufacturing the speaker magnetic circuit of embodiment 13 of the present invention.

FIG. 19 is a schematic sectional view showing the structure of a speaker magnetic circuit according to embodiment 14 of the present invention.

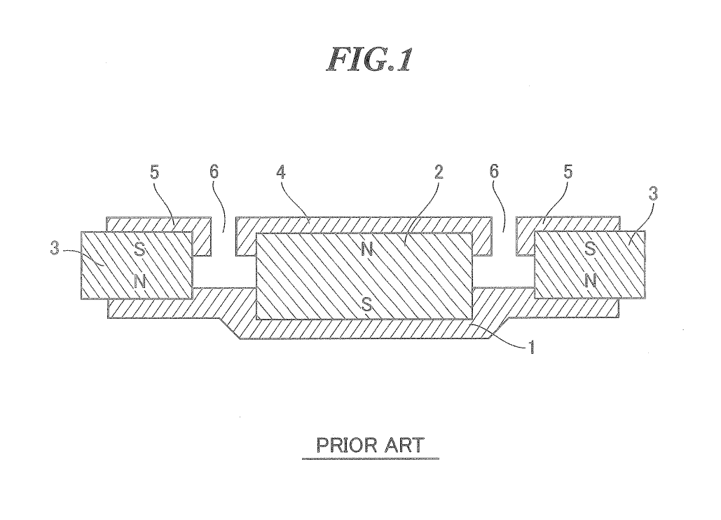

### BEST MODE FOR CARRYING OUT THE INVENTION

### Embodiment 1

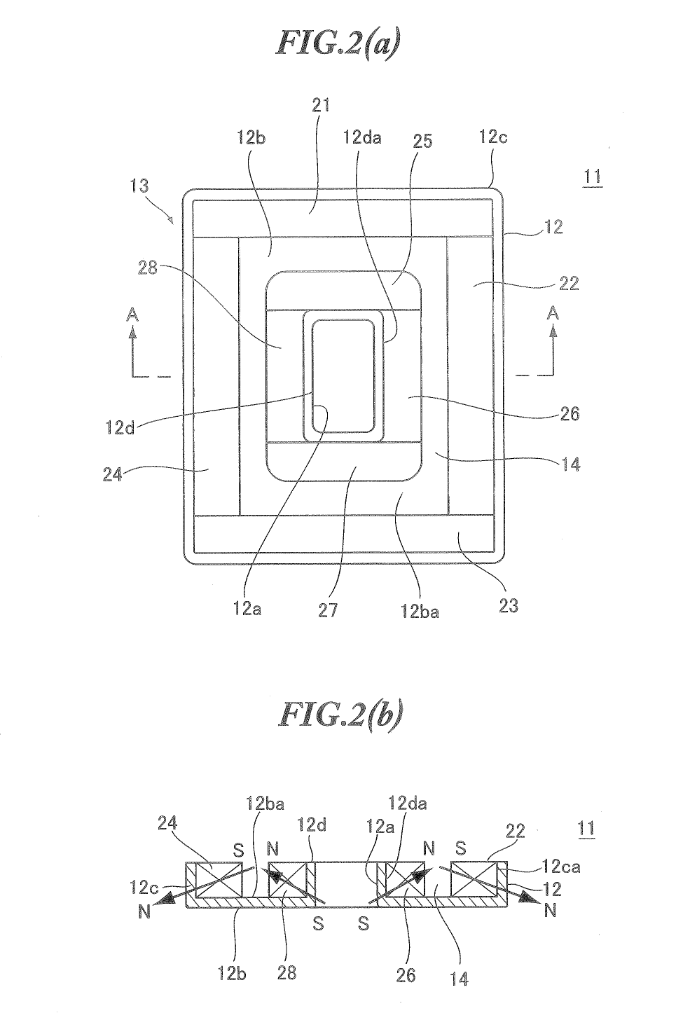

FIG. 2 is a schematic view showing the structure of a speaker magnetic circuit 11 according to embodiment 1 of the present invention, wherein FIG. 2(a) is a plan view and FIG. 2(b) is a sectional view taken along a line A-A in FIG. 2(a). In embodiment 1 of the present invention, the speaker magnetic circuit 11 comprises a yoke 12 and a magnet group 13. The speaker magnetic circuit 11 is about 15 mm inlongitudinal length, about 10 mm intransverse length, and about 1.5 mm in thickness.

The yoke 12 is made of a pure iron, an oxygen-free steel, a silicon steel or the like. The whole shape of the yoke 12 is substantially rectangular in a plan view. A through-hole 12a having a substantially rectangular shape is formed at a substantially central portion of the yoke 12. The yoke 12 is formed by integrally including a bottom portion 12b, an outer circumferential side portion 12c, and an inner circumferential side portion 12d. The bottom potion 12b has a substantially square ring-shaped structure. The outer circumferential side portion 12c is set substantially upright on the outer edge of the bottom portion 12b, while the inner circumferential portion 12d is set substantially upright on the inner edge of the bottom portion 12b.

The magnet group 13 comprises outer magnets 21-24 and inner magnets 25-28. The outer magnets 21-24 and the inner magnets 25-28 are made of a permanent magnet material such as Nd magnet, Sm—Co magnet, Al—Ni—Co magnet, ferrite magnet or the like. The outer magnets 21-24 and the inner magnets 26, 28 are each in a substantially prism shape. On the other hand, when the magnets 25, 27 are fixed to the upper surface 12ba of the bottom portion 12b of the yoke 12, among eight corners of the inner magnets 25 and 27, four corners opposing the outer circumferential side portion 12c of the yoke 12 are rounded The outer magnets 21-24 and the inner magnets 25-28 are each in a thickness substantially equal to a distance from the upper surface 12ba of the bottom portion 12b of the yoke 12 to the upper end of the outer circumferential side portion 12c.

The outer magnets 21-24 are in contact not only with the upper surface 12ba of the bottom portion 12b and the inner surface 12ca of the outer circumferential side portion 12c of the yoke 12, but also with other adjacent outer magnets, and are fixed to the yoke 12 with an adhesive agent. On the other hand, the inner magnets 25-28 are in contact not only with the upper surface 12ba of the bottom portion 12b and the outer circumferential surface 12da of the inner circumferential side portion 12d of the yoke 12, but also with other adjacent inner magnets, and are fixed to the yoke 12 with an adhesive agent.

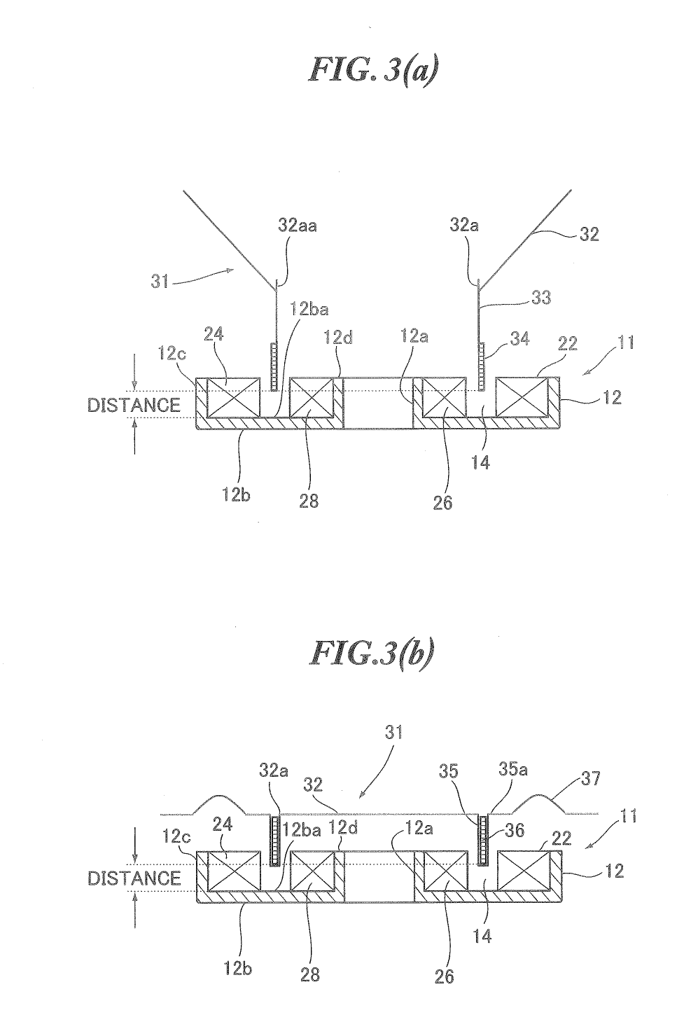

A magnetic interval (magnetic gap) 14 is formed between the outer magnets 21-24 and the inner magnets 25-28. The outer magnets 21-24 and the inner magnets 25-28 are magnetized in an oblique direction with respect to their thickness direction. Specifically, the outer magnets 21-24, as shown in FIG. 2(b), have S pole on the front side (in sound emission direction) of the speaker device (see FIG. 3) including the speaker magnetic circuit 11 and N pole on the rear side of the speaker device (opposite to sound emission direction), and are magnetized in a direction at an angle of about 10°-70° with respect to the horizontal direction facing outwardly from the center of the yoke 12. In this way, if the outer magnets 21-24 are magnetized at an angle of about 10°-70° as described above, a peak of the magnetic flux density can be disposed near a position where a voice coil described below is supported. Further, if the outer magnets 21-24 have S pole on the front side of the speaker device (in sound emission direction) and N pole on the rear side of the speaker device (opposite to sound emission direction), and are magnetized in a direction at an angle of about 30°-45° with respect to the horizontal direction facing outwardly from the center of the yoke 12, it is possible to increase a magnetic flux density in the magnetic gap 14.

On the other hand, the inner magnets 25-28, as shown in FIG. 2(b), have S pole on the rear side of the speaker device (opposite to sound emission direction) and N pole on the front side of the speaker device (in sound emission direction) and are magnetized at an angle of about 10°-70° with respect to the horizontal direction facing outwardly from the center of the yoke 12. In this way, if the inner magnets 25-28 are magnetized at an angle of about 10°-70° as described above, the peak of magnetic flux density can be disposed near the position where the voice coil described below is supported. Moreover, if the inner magnets 25-28 have S pole on the rear side of the speaker device (opposite to sound emission direction) and N pole on the front side of the speaker device (in sound emission direction) and are magnetized at an angle of about 30°-45° with respect to the horizontal direction facing outwardly from the center of the yoke 12, it is possible to increase the magnetic flux density in the magnetic gap 14.

FIG. 3 provides schematic sectional views showing the structure of a speaker device containing the speaker magnetic circuit shown in FIG. 2, wherein FIG. 3(a) shows an example in which the longitudinal cross-sectional shape of a diaphragm is generally conical (cone-shaped) and FIG. 3(b) shows an example in which the diaphragm is generally tabular. The speaker device has the speaker magnetic circuit 11 described above and a diaphragm assembly 31. The diaphragm assembly 31 comprises a diaphragm 32, a voice coil bobbin 33, a voice coil 34, and a frame (not shown). The diaphragm 32 has a generally rectangular shape in a plan view, its longitudinal cross sectional shape is generally conical (cone-shaped) (see FIG. 3(a)) or generally tabular (see FIG. 3(b)).

A material forming the diaphragm 32 can be a paper, a cloth formed of a fiber, a woven fabric formed of a fiber, a non-woven fabric formed of a fiber, or a woven fabric impregnated with a phenol resin, a silicone resin or a solution containing such a resin and an organic solvent. The diaphragm 32 can also be formed of a metal material, a synthetic resin, or an acryl foamed material. The metal material can be aluminum, titanium, duralumin, beryllium, magnesium, or an alloy thereof. The synthetic resin can be a polypropylene, a polyethylene, a polystyrene, a polyethylene terephthalate, a polyethylene naphthalene, a polymethyl methacrylate, a polycarbonate, a polyarylate, an epoxy resin or the like. In addition, an acryl foamed material can be made by using a methyl methacrylate, a methacrylate, a styrene, an anhydrous maleic acid, and a methacrylamide as raw materials.

A through-hole 32aa having a generally rectangular shape in a plan view is formed on the inner circumference 32a of the diaphragm 32 shown in FIG. 3(a). The outer peripheral surface of the voice coil bobbin 33 having a generally square and tubular shape is fixed near its upper end to the through-hole 32aa with an adhesive agent. A voice coil 34 is wound around the outer peripheral surface of the voice coil bobbin 33 near the lower end thereof. On the other hand, a voice coil housing part 35 having a generally rectangular shape in a plan view is formed integrally with the diaphragm 32, in proximity of the inner circumference 32a of the diaphragm 32 shown in FIG. 3(b). A voice coil 36 having a generally cylindrical shape is housed in the voice coil housing part 35, and is fixed therein with an adhesive agent. In addition, in proximity of the outer circumference 35a of the voice coil housing part 35, an edge portion 37 having a generally square and annular shape in a plan view is formed integrally with the voice coil housing part 35 and the diaphragm 32.

Both ends of each of the voice coils 34 and 36 are led out respectively along the voice coil bobbin 33 or the diaphragm 32, and electrically connected to a pair of lead wires (not shown) near the inner circumference of the diaphragm 32. The pair of lead wires (not shown) are made of bending-resistant wires having a plurality of thin electric wires twisted.

When audio signals (sound current) are supplied to the speaker device having the above-described structure, the audio current is supplied to the voice coil 34 or the voice coil 36 through the pair of lead wires (not shown). The outer magnets 21-24 and the inner magnets 25-28 are magnetized in an oblique direction with respect to their thickness direction. Therefore, the magnetic flux developed from the inner magnets 25-28 flows towards the outer magnets 21-24. Consequently, the magnetic fluxes can be efficiently collected at a position of the voice coil (described below) capable of ensuring the enough vibration amplitude for the voice coil 34 or the voice coil 36.

In this way, under an electromagnetic force (Lorentz force) produced by an interaction between the magnetic flux developed from the magnet group 13 constituting the speaker magnetic circuit 11 and the audio current flowing to the voice coil 34 or 36, a driving force in the axial direction of the speaker device is induced on the voice coil 34 or 36. This driving force is transferred through the voice coil 34 or 36 to the diaphragm 32. The diaphragm 32 oscillates under the driving force, thus emitting a sound wave corresponding to the audio current towards a space on the front side (in sound emission direction)

As described above, in embodiment 1 of the present invention, since the magnetization direction of the outer magnets 21-24 and the inner magnets 25-28 is oblique with respect to the thickness direction of the magnets and since the magnetic flux developed from the inner magnets 25-28 flows toward the outer magnets 21-24, it is possible to reduce an occurrence of a magnetic flux leakage flowing towards the bottom portion 12b of the yoke 12. Consequently, it becomes possible to increase the magnetic flux density in the magnetic gap 14 formed between the inner magnets 25-28 and the outer magnets 21-24, thereby ensuring a peak of the magnetic flux density at an position capable of inducing an enough vibration amplitude on the voice coil 34 and 36 constituting the speaker device shown in FIG. 3.

In addition, since the bottom surface and the side surface of the outer magnets 21-24 and the inner magnets 25-28 are in contact with the upper surface 12ba of the bottom portion 12b of the yoke 12, as well as with the inner surface 12ca of the outer circumferential side portion 12c or the outer surface 12da of the inner circumferential side portion 12d of the yoke 12, it becomes possible to reduce the magnetic flux leakage. Meanwhile, it will also be possible to increase the magnetic flux density in the magnetic gap 14 by increasing the contact area between the outer magnets 21-24 or the inner magnets 25-28 and the yoke 12 or increasing the sizes of the outer magnets 21-24 or the inner magnets 25-28. In particular, if the outer magnets 21-24 and the inner magnets 25-28 are made of rare-earth magnet, the magnetic flux density in the magnetic gap 14 will be greatly affected by the contact area between the outer magnets 21-24 or the inner magnets 25-28 and the yoke 12. If the outer magnets 21-24 and the inner magnets 25-28 are made of ferrite magnet, the magnetic flux density in the magnetic gap 14 will be greatly affected by the sizes of the outer magnets 21-24 and the inner magnets 25-28.

Consequently, even for a speaker device including the afore-mentioned thin-type speaker magnetic circuit 11, it is still possible to obtain a high sensitivity. Further, according to embodiment 1 of the present invention, since the magnetic flux leakage can be reduced, it becomes possible to use a short voice coil without using a long voice coil to maximally ensure an area which allows the magnetic flux to act.

FIG. 4 shows an example indicating a magnetic flux density distribution with respect to a distance from the upper surface 12ba of the bottom portion 12b of the yoke 12. In FIG. 4, curve a and b represent the characteristics of the speaker magnetic circuit 11 according to embodiment 1 of the present invention. Curve a represents the characteristic of the magnetic circuit when the magnetization direction of the outer magnets 21-24 and the inner magnets 25-28 is at about an angle of 60° with respect to the horizontal direction facing outwardly from the center of the yoke 12. Curve b represents the characteristic of the magnetic circuit when the magnetization direction of the outer magnets 21-24 and the inner magnets 25-28 is at an angle of about 30° with respect to the horizontal direction facing outwardly from the center of the yoke 12. On the other hand, curve c represents the characteristic of a conventional speaker magnetic circuit. Further, in FIG. 4, BCP represents the position of voice coil. This position BCP of the voice coil represents a static position of the voice coil 34 when the speaker device is in its static state (the speaker device is not in its being-driven condition). As shown in FIG. 4, as compared to curve c, the peak of the magnetic flux density distribution represented by curve a is closer to the center of the position BCP of voice coil. Further, the peak of the magnetic flux density distribution represented by curve b is higher than that represented by curve c. Thus, as can be seen from the magnetic flux density distribution shown in FIG. 4, using the speaker magnetic circuit 11 according to embodiment 1 of the present invention makes it possible to ensure a high magnetic flux density in the magnetic gap 14.

### Embodiment 2

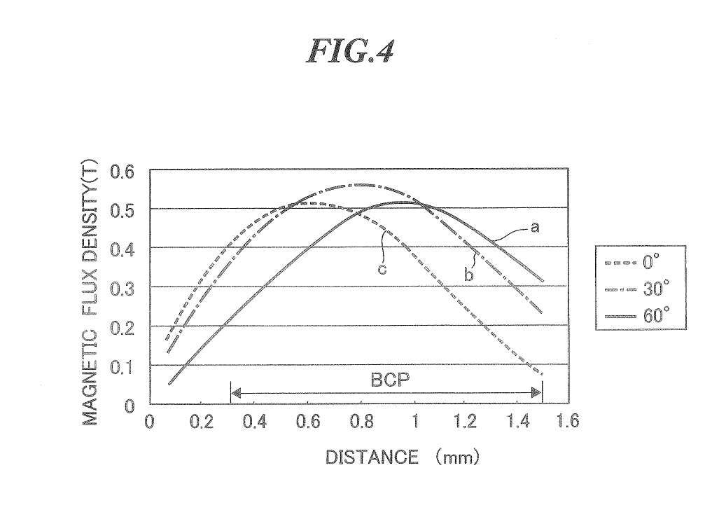

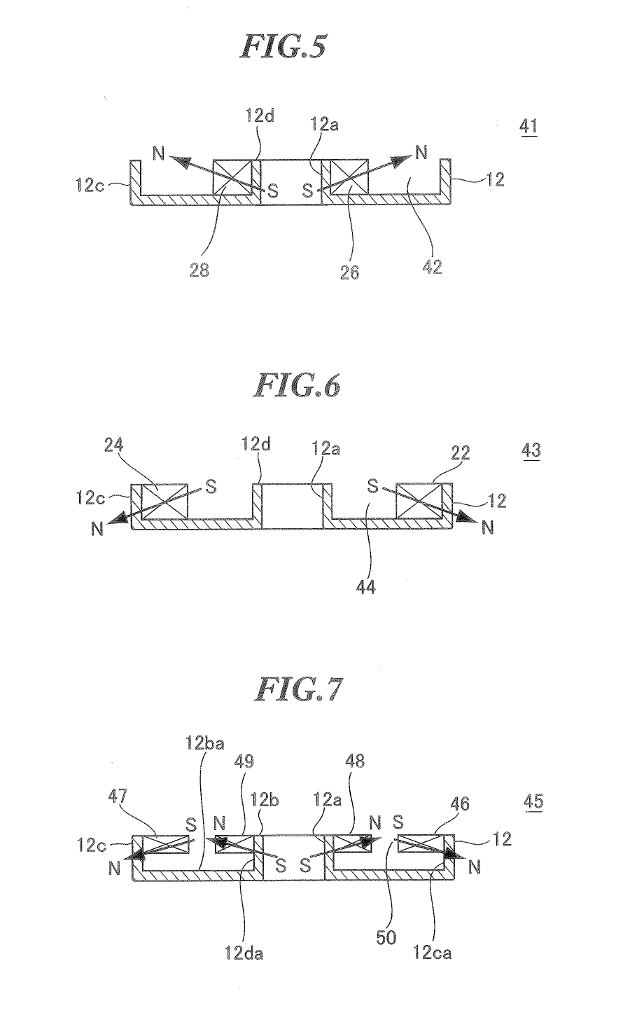

In embodiment 1 described above, an example is shown which involves the provision of both the outer magnets 21-24 and the inner magnets 25-28. However, the present invention should not be limited to this example. For example, it is also possible to provide only the inner magnets 25-28, such as the speaker magnetic circuit 41 shown in FIG. 5. In the example shown in FIG. 5, a magnetic interval (magnetic gap) 42 is formed between the outer side face of the inner magnets 25-28 and the inner surface of the outer circumferential portion 12c of the yoke 12. In addition, it is also possible to provide only the outer magnets 21-24, such as a speaker magnetic circuit 43 shown in FIG. 6. In the example shown in FIG. 6, a magnetic interval (magnetic gap 44) is formed between the inner side surface of the outer magnets 21-24 and the outer surface of the inner circumferential side portion 12d of the yoke 12. In FIG. 5 and FIG. 6, the parts corresponding to those shown in FIG. 2(b) are labeled with the same reference numerals as those shown in FIG. 2(b), with the explanations thereof omitted.

In this way, since the speaker device including the speaker magnetic circuit 41 or 43 can prevent a decrease of magnetic flux density in the magnetic gap 42 or 44, it is possible to ensure a great magnetic flux density in the magnetic gap 42 or 44. Furthermore, it is also possible to reduce the number of parts involved.

### Embodiment 3

In embodiment 1 described above, there is shown an example in which the bottom surfaces and side faces of the outer magnets 21-24 and the inner magnets 25-28 are in contact with the upper surface 12ba of the bottom portion 12b of the yoke 12, the inner surface 12ca of the outer circumferential side portion 12c, or the outer surface 12da of the inner circumferential side portion 12d. The above-discussed embodiment 1 also shows an example in which the outer magnets 21-24 and the inner magnets 25-28 are in a thickness substantially equal to a distance from the upper surface 12ba of the bottom portion 12b of the yoke 12 to the upper end of outer circumferential side portion 12c. However, the present invention is not limited to these examples. For example, in place of the outer magnets 21-24 and the inner magnets 25-28, as in the speaker magnetic circuit 45 shown in FIG. 7, intervals are provided between the upper surface 12ba of the bottom portion 12b of the yoke 12 and the outer magnets 21-24 as well as the inner magnets 25-28, while the side faces of the outer magnets 21-24 and the inner magnets 25-28 are attached to the outer circumferential side portion 12c and the inner circumferential side portion 12d of the yoke 12. In FIG. 7, the parts corresponding to those shown in FIG. 2 are labeled with the same reference numerals as those shown in FIG. 2, with the descriptions thereof omitted.

In the example shown in FIG. 7, there are outer magnets 46 and 47 corresponding to the outer magnets 22 and 24 shown in FIG. 2(a) and FIG. 2(b) but thinner than the outer magnets 22 and 24, such as having a thickness which is substantially half of the thickness of the outer magnets 22 and 24. In the same example, there are inner magnets 48 and 49 corresponding to the inner magnets 26 and 28 shown in FIG. 2(a) and FIG. 2(b) but thinner than the inner magnets 26 and 28, such as having a thickness which is substantially half of the thickness of the inner magnets 26 and 28. On the other hand, FIG. 7 does not show two other outer magnets corresponding to the outer magnets 21 and 23 shown in FIG. 2(a) but thinner than the outer magnets 21 and 23, such as having a thickness which is substantially half of the thickness of the outer magnets 21 and 23. FIG. 7 does not show two other inner magnets corresponding to the inner magnets 25 and 27 shown in FIG. 2(a) but thinner than the inner magnets 25 and 27, such as having a thickness which is substantially half of the thickness of the inner magnets 25 and 27.

The above-described outer magnets 46, 47 and the two other outer magnets (not shown) are in contact with the inner surface 12ca of the outer circumferential side portion 12c of the yoke 12, as well as with other adjacent outer magnets, and are fixed to the yoke 12 with an adhesive agent. On the other hand, the above-described inner magnets 48, 49 and the two other inner magnets (not shown) are in contact with the outer surface 12da of the inner circumferential side portion 12d of the yoke 12, as well as with other adjacent inner magnets, and are fixed to the yoke 12 with an adhesive agent. In the example shown in FIG. 7, a magnetic interval (magnetic gap) 50 is formed between the outer surfaces of the inner magnets 48, 49 as well as the two other inner magnets (not shown) and the inner surfaces of the outer magnets 46, 47 as well as the two other outer magnets (not shown).

Moreover, the outer magnets 46, 47 and the two other outer magnets (not shown) have S pole on the front side of the speaker device including the speaker magnetic circuit 45 (in sound emission direction) and N pole on the rear side of the speaker device (opposite to sound emission direction), and are magnetized in a direction at an angle of about 10°-70° with respect to the horizontal direction to facing outwardly from the center of the yoke 12. In this way, if the outer magnets 46, 47 and the two other outer magnets (not shown) are magnetized at an angle of about 10°-70° as described above, a peak of the magnetic flux density can be ensured near a position where a voice coil is supported. Further, if the outer magnets 46, 47 and the two other outer magnets (not shown) have S pole on the front side of the speaker device (in sound emission direction) and N pole on the rear side of the speaker device (opposite to sound emission direction), and are magnetized in a direction at an angle of about 30°-45° with respect to the horizontal direction e facing outwardly from the center of the yoke 12, it is possible to increase a magnetic flux density in the magnetic gap 50.

On the other hand, the inner magnets 48, 49 and the two other inner magnets (not shown) have S pole on the rear side of the speaker device (opposite to sound emission direction) and N pole on the front side of the speaker device (in sound emission direction) and are magnetized at an angle of about 10°-70° with respect to the horizontal direction facing outwardly from the center of the yoke 12. In this way, if the inner magnets 48, 49 and the two other inner magnets (not shown) are magnetized at an angle of about 10°-70° as described above, the peak of magnetic flux density can be ensured near the position where the voice coil described below is supported. Moreover, if the inner magnets 48, 49 and the two other inner magnets (not shown) have S pole on the rear side of the speaker device (opposite to sound emission direction) and N pole on the front side of the speaker device (in sound emission direction) and are magnetized at an angle of about 30°-45° with respect to the horizontal direction facing outwardly from the center of the yoke 12, it is possible to increase the magnetic flux density in the magnetic gap 14.

In addition, it is also possible to provide a spacer between the upper surface of the bottom portion 12a of the yoke 12 on one hand and each of the bottom surfaces of the outer magnets 46, 47, the two other outer magnets (not shown), the inner magnets 48, 49, and the two other inner magnets (not shown) on the other.

In this way, as the speaker device concluding the speaker magnetic circuit 45 can prevent a decrease of the magnetic flux density in the magnetic gap 50, it is possible to ensure a great magnetic flux density in the magnetic gap 50,

### Embodiment 4

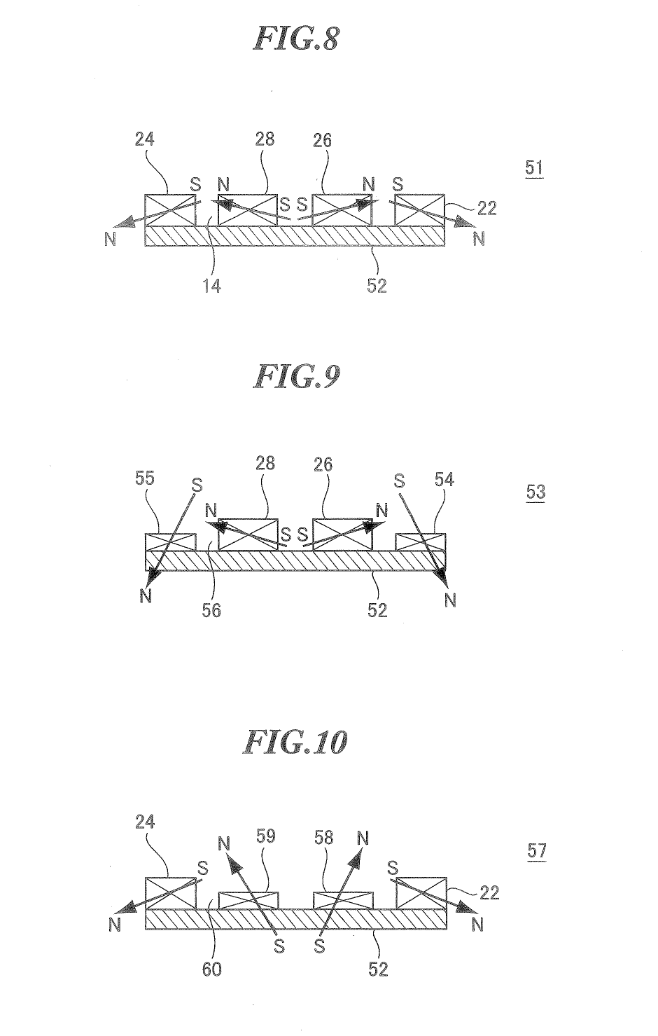

In embodiments 1-3 described above, there is shown an example in which the yoke 12 is obtained by integrally forming the bottom portion 12b, the outer circumferential side portion 12c, and the inner circumferential side portion 12d. However, the present invention should not be limited to this example. For example, it is possible to replace the yoke 12 with a yoke 52 having a generally rectangular tabular shape in a plan view, as shown in FIG. 8 which illustrates a speaker magnetic circuit 51. In FIG. 8, parts corresponding to those shown in FIG. 2 are labeled with the same reference numerals as those shown in FIG. 2, with the description thereof omitted. Further, in FIG. 8, the outer magnets 22, 24 and the inner magnets 26, 28 are shown, but the outer magnets 21, 23 in FIG. 2(a) and the inner magnets 25, 27 in FIG. 2(a) are not shown. The yoke 52 can be made of a pure iron, an oxygen-free steel, a silicon steel or the like.

The above-described outer magnets 22, 24 and the two outer magnets 21, 23 (not shown) are in contact with the upper surface of the outer circumference of the yoke 52, and are fixed to the yoke 52 with an adhesive agent. The inner magnets 26, 28 are provided at a certain interval in a generally central position of the upper surface of the yoke 52. Meanwhile, the two inner magnets 25, 27 (not shown) are arranged such that their upper and lower ends of the same side surfaces are in contact with the end faces of the inner magnets 26, 28, and are fixed to the yoke 52 by applying an adhesive agent to the contacting portions. In the example shown in FIG. 8, a magnetic gap 14 is formed between the outer circumferential surfaces of the inner magnets 26, 28 as well as the two other inner magnets 25, 27 (not shown) and the inner circumferential surfaces of the outer magnets 22, 24 as well as the two other outer magnets 21, 23 (not shown). Using the speaker device including the speaker magnetic circuit 51 can prevent a decrease of the magnetic flux density in the magnetic gap 14, thereby ensuring a high magnetic flux density in the magnetic gap 14.

### Embodiment 5

FIG. 9 is a schematic sectional view showing the structure of a speaker magnetic circuit 53 according to embodiment 5 of the present invention. In FIG. 9, parts corresponding to those shown in FIG. 8 are labeled with the same reference numerals as those shown in FIG. 8, with the description thereof omitted. As shown in FIG. 9, the outer magnets 22, 24 shown in FIG. 8 and two other outer magnets 21, 23 (not shown) have been replaced with outer magnets 54, 55 and two other outer magnets (not shown). Though the outer magnets 54, 55 and the two other outer magnets (not shown) are made of a material similar to the outer magnets 21-24, they are thinner than the inner magnets 26 and 28, having a thickness which is substantially a half of the thickness of the inner magnets 26 and 28. Moreover, though FIG. 9 shows the outer magnets 54, 55 and the inner magnets 26, 28, the figure does not show the two other outer magnets corresponding to the outer magnets 21, 23 in FIG. 2(a) and having a smaller thickness than the outer magnets 21, 23 (for example, half the thickness of the outer magnets 21, 23). Besides, FIG. 9 does not show the inner magnets 25 and 27 shown in FIG. 2(a), either.

The outer magnets 54 and 55 described above and two other outer magnets (not shown) are in contact with the upper surface of the outer circumference of the yoke 52, as well as with other adjacent outer magnets, and are fixed to the yoke 52 with an adhesive agent. On the other hand, the inner magnets 26 and 28 are provided at a certain interval from each other in a generally central portion of the yoke 52, while two other inner magnets (not shown) are arranged in such a condition that the upper and lower ends on the same side surface are in contact with the end surfaces of the inner magnets 26 and 28, and are fixed to the yoke 52 by applying an adhesive agent to the contacting portions. In the example shown in FIG. 9, a magnetic gap 56 is formed between the outer circumferential surfaces of the inner magnets 26, 28 and the two other inner magnets (not shown) on one hand and the inner circumferential surfaces of the outer magnets 54, 55 and two other outer magnets (not shown) on the other.

Moreover, the outer magnets 54, 55 and the two other outer magnets (not shown) have S pole on the,front side of the speaker device including the speaker magnetic circuit 53 (in sound emission direction) and N pole on the rear side of the speaker device (opposite to sound emission direction), and are magnetized in a direction at an angle of about 10°-70° with respect to the horizontal direction facing outwardly from the center of the yoke 52. In this way, if the outer magnets 54, 55 and the two other outer magnets (not shown) are magnetized at an angle of about 10°-70° as described above, a peak of the magnetic flux density can be ensured near a position where a voice coil is supported. Further, if the outer magnets 54, 55 and the two other outer magnets (not shown) have S pole on the front side of the speaker device (in sound emission direction) and N pole on the rear side of the speaker device (opposite to sound emission direction), and are magnetized in a direction at an angle of about 30°-45° with respect to the horizontal direction facing outwardly from the center of the yoke 52, it is possible to increase a magnetic flux density in the magnetic gap 56. In addition, if the magnetization direction of the inner magnets 25-28 is different from the magnetization direction of the outer magnets 54, 55 and two other outer magnets (not shown), it is possible to ensure the peak of the magnetic flux density near the position where the voice coil is supported.

According to the above-described structure, the speaker device including the speaker magnetic circuit 52 can prevent a decrease of magnetic flux density in the magnetic gap 56, thereby ensuring a great magnetic flux density in the magnetic gap 56.

### Embodiment 6

FIG. 10 is a schematic sectional view showing the structure of the speaker magnetic circuit 57 according to embodiment of the present invention. In FIG. 10, the parts corresponding to those shown in FIG. 8 are labeled with the same reference numerals as those shown in FIG. 8, with the description thereof omitted. As shown in FIG. 10, the inner magnets 26, 28 and the two other inner magnets 25, 27 (not shown) have been replaced with inner magnets 58, 59 and two other inner magnets (not shown). Though the inner magnets 58, 59 and the two other outer magnets (not shown) are made of a material similar to the inner magnets 25-28, they are thinner than the outer magnets 22 and 24, having a thickness which is approximately half of the thickness of the magnets 22 and 24. FIG. 10 shows the inner magnets 58, 59 and the outer magnets 22, 24, but does not show the two inner magnets corresponding to the inner magnets 25, 27 shown in FIG. 2(a) and thinner than the inner magnets 25 and 27 (having a thickness which is half of the thickness of the inner magnets 25 and 27). Besides, FIG. 10 does not show the outer magnets 21, 23 shown in FIG. 2(a).

The inner magnets 58, 59 and the two other inner magnets are provided in a generally central position of the upper surface of the yoke 52, with the inner magnets 58, 59 separated at a predetermined interval. Meanwhile, the two inner magnets (not shown) are arranged in a condition such that the upper and lower ends on the same side surface are in contact with the end faces of the inner magnets 58 and 59, and are fixed to the yoke 52 by applying an adhesive agent to the contacting portions. On the other hand, the outer magnets 22, 24 and the two other outer magnets 21 and 23 (not shown) are in contact with the upper surface of the outer circumference of the yoke 52, as well as with other adjacent inner magnets, and are fixed to the yoke 52 with an adhesive agent. In the example shown in FIG. 10, a magnetic gap 60 is formed between the outer circumferential surfaces of the inner magnets 58, 59 and the two other inner magnets (not shown) on one hand and the inner circumferential surfaces of the outer magnets 22, 24 and the two other outer magnets 21, 23 (not shown) on the other.

Moreover, the inner magnets 58, 59 and the two other inner magnets (not shown) have S pole on the rear side of the speaker device including the speaker magnetic circuit 57 (opposite to sound emission direction) and N pole on the front side of the speaker device (in sound emission direction), and are magnetized in a direction at an angle of about 10°-70° with respect to the horizontal direction facing outwardly from the center of the yoke 52. In this way, if the inner magnets 58, 59 and the two other inner magnets (not shown) are magnetized at an angle of about 10°-70° as described above, a peak of the magnetic flux density can be ensured near a position where a voice coil is supported. Further, if the inner magnets 58, 59 and the two other inner magnets (not shown) have S pole on the rear side of the speaker device (opposite to sound emission direction) and N pole on the front side of the speaker device (in sound emission direction), and are magnetized in a direction at an angle of about 30°-45° with respect to the horizontal direction facing outwardly from the center of the yoke 52, it is possible to increase a magnetic flux density in the magnetic gap 60. In addition, if the magnetization direction of the outer magnets 21-24 is different from the magnetization direction of the inner magnets 58, 59 and two other inner magnets (not shown), it is possible to ensure the peak of the magnetic flux density near the position where the voice coil is supported.

According to the above-described structure, the speaker device including the speaker magnetic circuit 57 can prevent a decrease of magnetic flux density in the magnetic gap 60, thereby ensuring a great magnetic flux density in the magnetic gap 60.

### Embodiment 7

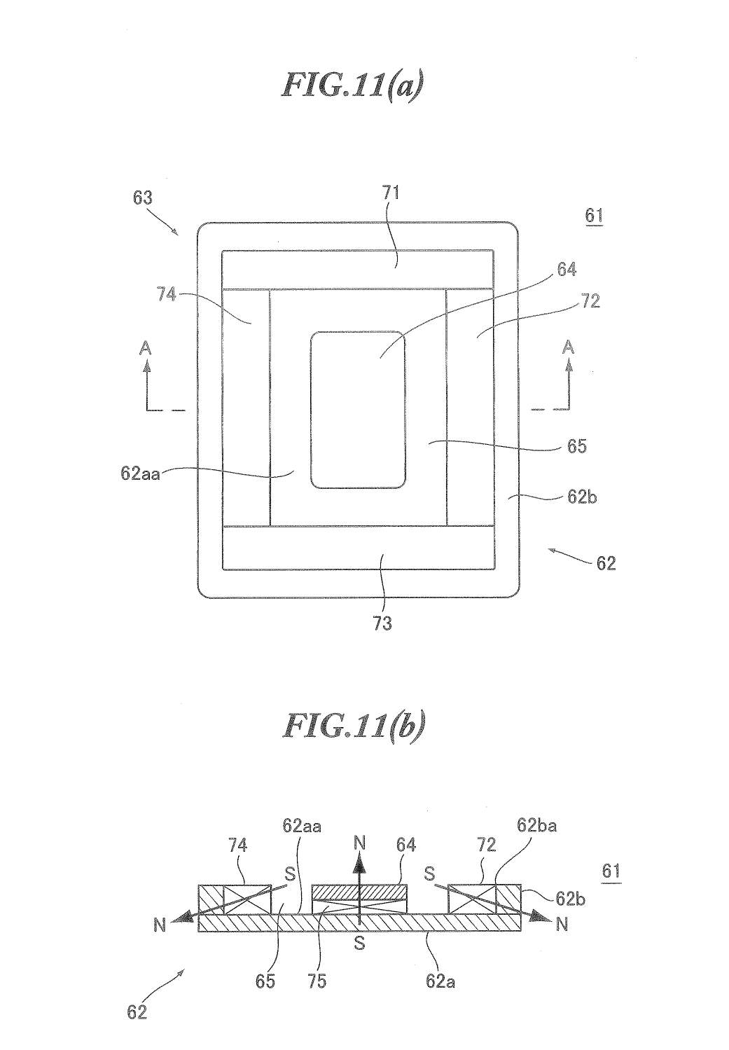

FIG. 11 is a schematic view showing the structure of a speaker magnetic circuit 61 according to embodiment 7 of the present invention, wherein FIG. 11(a) is a plan view and FIG. 11(b) is a sectional view taken along A-A line of FIG. 11(a). The speaker magnetic circuit 61 of embodiment 7 has a yoke 62, a magnet group 63, and a plate 64. The yoke 62 can be made of, for example, a pure iron, an oxygen-free steel, a silicon steel or the like. The whole shape of the yoke 62 is generally rectangular and tabular in a plan view. The yoke 62 can be structured such that the bottom portion 62a and the outer circumferential edge portion 62b are formed separately or integrally. In the example shown in FIG. 11, the bottom portion 62a and the outer circumferential edge portion 62b are formed separately. The shape of the bottom portion 62a is generally rectangular and tabular in a plan view. The outer circumferential edge portion 62b has a generally square and ring-shape in a plan view. The outer circumferential edge portion 62b is in contact with the outer circumference of the bottom portion 62a and is fixed to the bottom portion 62a with an adhesive agent.

The magnet group 63 comprises outer magnets 71-74 and inner magnet 75. The outer magnets 71-74 and the inner magnet 75 can be made of a permanent magnet material such as Nd magnet, Sm—Co magnet, Al—Ni—Co magnet, ferrite magnet or the like. The outer magnets 71-74 are in a generally prism shape. On the other hand, the shape of the inner magnet 75 is generally rectangular and planar in a plan view. In the example shown in FIG. 11, the outer magnets 71-74 are in a thickness substantially equal to a distance from the upper surface 62aa of the bottom portion 62a of the yoke 62 to the upper end of the outer circumferential edge portion 62b. Nevertheless, in the example shown in FIG. 11, the inner magnet 75 is in a thickness smaller than the thickness of the outer magnets 71-74, such as a half of a distance from the upper surface 62aa of the bottom portion 62a of the yoke 62 to the upper end of the outer circumferential edge portion 62b.

The outer magnets 71-74 are in contact not only with the upper surface 62aa of the bottom portion 62a and the inner circumferential surface 62ba of the outer circumferential edge portion 62c of the yoke 62, but also with other adjacent outer magnets, and are fixed to the yoke 62 with an adhesive agent. On the other hand, the inner magnet 75 is fixed to a generally central position of the upper surface 62aa of the bottom portion 62a of the yoke 62 with an adhesive agent. The plate 64 is fixed on upper surface of the inner magnet 75 with an adhesive agent. The shape of the plate 64 is generally rectangular and tabular in a plan view, having a size substantially the same as the inner magnet 74. Here, the plate 64 can be made of, for example, a soft magnetic material (e.g., a low carbon steel).

A magnetic interval (magnetic gap) 65 is formed between the outer magnets 71-74 and the inner magnet 75. The outer magnets 71-74 are magnetized in an oblique direction with respect to their thickness direction. Specifically, the outer magnets 71-74, as shown in FIG. 11(b), have S pole on the front side of the speaker device including the speaker magnetic circuit 61 (in sound emission direction) and N pole on the rear side of the speaker device (opposite to sound emission direction), and are magnetized in a direction at an angle of about 10°-70° with respect to the horizontal direction facing outwardly from the center of the yoke 62.

In this way, if the outer magnets 71-74 are magnetized at an angle of about 10°-70° as described above, a peak of the magnetic flux density can be ensured near a position where a voice coil described below is supported. Further, if the outer magnets 71-74 have S pole on the front side of the speaker device (in sound emission direction) and N pole on the rear side of the speaker device (opposite to sound emission direction), and are magnetized in a direction at an angle of about 30°-45° with respect to the horizontal direction facing outwardly from the center of the yoke 62, it is possible to increase a magnetic flux density in the magnetic gap 65.

On the other hand, the inner magnet 75, as shown in FIG. 2(b), has S pole on the rear side of the speaker device (opposite to sound emission direction) and N pole on the front side of the speaker device (in sound emission direction) and is magnetized in a direction generally parallel to the vertical direction (thickness direction of the inner magnet 75).

In this way, with the speaker device containing the speaker magnetic circuit 6, it is possible to prevent a decrease of the magnetic flux density within the magnetic gap 65, making it possible to ensure a great magnetic flux density in the magnetic gap 65. Further, if the magnetization direction of the outer magnets 71-74 is different from the magnetization direction of the inner magnet 75, it is possible to ensure a peak of the magnetic flux density near the position where the voice coil is supported.

### Embodiment 8

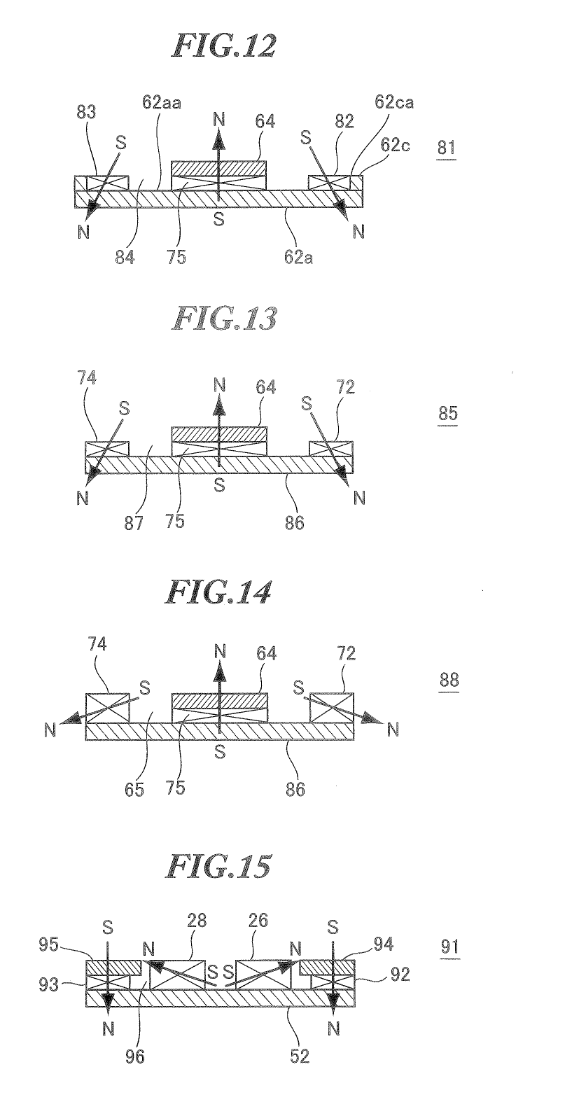

FIG. 12 is a schematic sectional view showing the structure of a speaker magnetic circuit 81 according to embodiment 8 of the present invention. In FIG. 12, the parts corresponding to those shown in FIG. 11 are labeled with the same reference numerals as those shown in FIG. 11, with the description thereof omitted. As shown in FIG. 12, the outer circumferential side portion 62b and the outer magnets 71-74 shown in FIG. 11 have been replaced with outer circumferential side portion 62c, outer magnets 82, 83, and two other outer magnets (not shown). The outer circumferential side portion 62c is made of a material similar to the outer circumferential side portion 62b, having a thickness substantially equal to the thickness of the inner magnet 75. FIG. 12 shows the inner magnet 75 and the outer magnets 82, 83, but does not show two other outer magnets corresponding to the outer magnets 71, 74 in FIG. 11 and having a thickness substantially equal to the thickness of the inner magnet 75.

The outer circumferential side portion 62c has a generally square and ring-shape in a plan view. The outer circumferential side portion 62c is in contact with the outer circumference of the bottom portion 62a, and is fixed to the bottom portion. 62a with an adhesive agent. The outer magnets 82, 83 and the two other outer magnets (not shown) are in contact with the upper surface 62aa of the bottom portion 62a and the inner circumferential surface 62ca of the outer circumferential side portion 62c, as well as with adjacent other outer magnets, and are fixed to the bottom portion 62a and the outer circumferential side portion 62c with an adhesive agent.

A magnetic interval (magnetic gap) 84 is formed between the outer magnets 82, 83 and the two other outer magnets (not shown) on one hand and the inner magnet 75 on the other. The outer magnets 82, 83 and two other outer magnets (not shown) are magnetized in an oblique direction with respect to their thickness direction. Specifically, the outer magnets 82, 83 and two other outer magnets (not shown), as shown in FIG. 12 for example, have S pole on the front side of the speaker device including the speaker magnetic circuit 81 (in sound emission direction) and N pole on the rear side of the speaker device (opposite to sound emission direction), and are magnetized at an angle of about 10°-70° with respect to the horizontal direction e facing outwardly from the center of the bottom portion 62a. Thus, if the outer magnets 82, 83 and the two other outer magnets (not shown.) are magnetized at an angle of about 10°-70° as described above, the peak of the magnetic flux density can be ensured near the position where the voice coil is supported. Moreover, for example, if the outer magnets 82, 83 and two other outer magnets (not shown) have S pole on the front side of the speaker device (in sound emission direction) and N pole on the rear side of the speaker device (opposite to sound emission direction) and are magnetized at an angle of about 30°-45° with respect to the horizontal direction facing outwardly from the center of the bottom portion 62a, it is possible to increase the magnetic flux density in the magnetic gap 84.

In this way, with the speaker device including the speaker magnetic circuit 81, it is possible to prevent a decrease of the magnetic flux density within the magnetic gap 84, making it possible to ensure a e great magnetic flux density in the magnetic gap 84. Further, if the magnetization direction of the outer magnets 82, 83 and the two other outer magnets (not shown) is different from the magnetization direction of the inner magnet 75, it is possible to ensure a peak of the magnetic flux density near the position where the voice coil is supported.

### Embodiment 9

FIG. 13 is a schematic sectional view showing the structure of the speaker magnetic circuit 85 according to embodiment of the present invention. In FIG. 13, the parts corresponding to those shown in FIG. 11 are labeled with the same reference numerals as those shown in FIG. 11, with the description thereof omitted. As shown in FIG. 13, the yoke 62 shown in FIG. 11 has been replaced with a yoke 86. The yoke 86 is made of a material similar to the bottom portion 62a, and has a generally rectangular tabular shape in a plan view, like the bottom 62a. The area of the yoke 86 is smaller than that of the bottom portion 62a by an area substantially equal to the bottom area of the outer circumferential side portion 62b (here, it has been removed). Here, FIG. 13 shows the inner magnet 75, the outer magnets 82, 83 and the plate 64, but does not show the outer magnets corresponding to the outer magnets 71, 74 in FIG. 11 and having a thickness substantially equal to the thickness of the inner magnet 75.

The outer magnets 82, 83 described above and the two other outer magnets (not shown) are in contact with the upper surface 62aa of the bottom portion 62a, as well as with adjacent other outer magnets, and are fixed to the yoke 86 with an adhesive agent. On the other hand, the inner magnet 75 is fixed to a substantially central position of the upper surface of the yoke 86. Here, a magnetic interval (magnetic gap) 87 is formed between the outer magnets 82, 83 and the two other outer magnets (not shown) on one hand and the inner magnet 75 on the other.

In this way, with the speaker device including the speaker magnetic circuit 85, it is possible to prevent a decrease of the magnetic flux density within the magnetic gap 87, making it possible to ensure a great magnetic flux density in the magnetic gap 87. Further, if the magnetization direction of the outer magnets 72, 74 and the two other outer magnets (not shown) is different from the magnetization direction of the inner magnet 75, it is possible to ensure a peak of the magnetic flux density near the position where the voice coil is supported.

### Embodiment 10

FIG. 14 is a schematic sectional view showing the structure of the speaker magnetic circuit 88 according to embodiment 10 of the present invention. In FIG. 14, parts corresponding to those shown in FIG. 11 are labeled with the same reference numerals as those shown in FIG. 11, with the description thereof omitted. As shown in FIG. 14, the yoke 62 shown in FIG. 11 is replaced with the yoke 86 shown in FIG. 13. That is, the structure of the speaker magnetic circuit 88 according to embodiment 10 is similar to the speaker magnetic circuit 61 according to embodiment 7, except the outer circumferential side portion 62b removed. Here, a magnetic interval (magnetic gap) 65 is formed between the outer magnets 72, 74 and two other outer magnets 71,73 (not shown)on one hand and the inner magnet 75 on the other.

In this way, with the speaker device including the speaker magnetic circuit 88, it is possible to prevent a decrease of the magnetic flux density within the magnetic gap 65, making it possible to ensure a e great magnetic flux density in the magnetic gap 65. Further, if the magnetization direction of the outer magnets 72, 74 and the two other outer magnets (not shown) is different from the magnetization direction of the inner magnet 75, it is possible to ensure a peak of the magnetic flux density near the position where the voice coil is supported.

### Embodiment 11

FIG. 15 is a schematic sectional view showing the structure of the speaker magnetic circuit 91 according to embodiment 11 of the present invention. In FIG. 15, parts corresponding to those shown in FIG. 9 are labeled with the same reference numerals as those shown in FIG. 9, with the description thereof omitted. As shown in FIG. 15, the outer magnets 54, 55 shown in FIG. 9 and two other outer magnets (not shown) is replaced with outer magnets 92, 93 and two other outer magnets (not shown). In addition, plates 94, 95 and two plates (not shown) are fixed respectively on the upper surfaces of the outer magnets 92, 93 and the two other outer magnets (not shown) with an adhesive agent. In the example shown in FIG. 15, the plates 94, 95 and the two plates (not shown) are wider than the corresponding outer magnets 92, 93 and the two outer magnets.

In addition, the outer magnets 92, 93 and the two outer magnets (not shown), as shown in FIG. 15 for example, have S pole on the front side of the speaker device including the speaker magnetic circuit 91 (in sound emission direction) and N pole on the rear side of the speaker device (opposite to sound emission direction), and are magnetized in a direction generally parallel to the vertical direction. Here, a magnetic interval (magnetic gap) 96 is formed between the outer magnets 92, 93 and the two outer magnets (not shown) on one hand and the inner magnets 26, 28 on the other.

In this way, with the speaker device including the speaker magnetic circuit 91, it is possible to prevent a decrease of the magnetic flux density within the magnetic gap 96, making it possible to ensure a great magnetic flux density in the magnetic gap 96. Further, if the magnetization direction of the outer magnets 92, 93 and the two other outer magnets (not shown) is different from the magnetization direction of the inner magnets 26, 28 and the two other inner magnets (not shown), it is possible to ensure a peak of the magnetic flux density near the position where the voice coil is supported. In this way, even if a speaker device including a speaker magnetic circuit 91 is thin and compact in size, it is possible to ensure a great magnetic flux density.

### Embodiment 12

In the embodiments described above, the whole shape of the speaker magnetic circuit is generally rectangular in a plan view. However, the present invention should not be limited by this. In fact, it is also possible for the whole shape of the speaker magnetic circuit to be generally circular, elliptical, or polygonal in a plan view. Further, in the embodiments described above, the outer magnets and the inner magnets provided on upper surface of the yoke are each composed of a plurality of magnets. Similarly, the present invention should not be limited by this. Actually, it is also possible for each or both of the outer magnets and the inner magnets to be formed of single one annular magnet. Hereinafter, description is given to explain an example in which an whole shape of the speaker magnetic circuit is generally circular in a plan view and the outer magnet and the inner magnet arranged on upper surface of the yoke are each formed of one annular magnet.

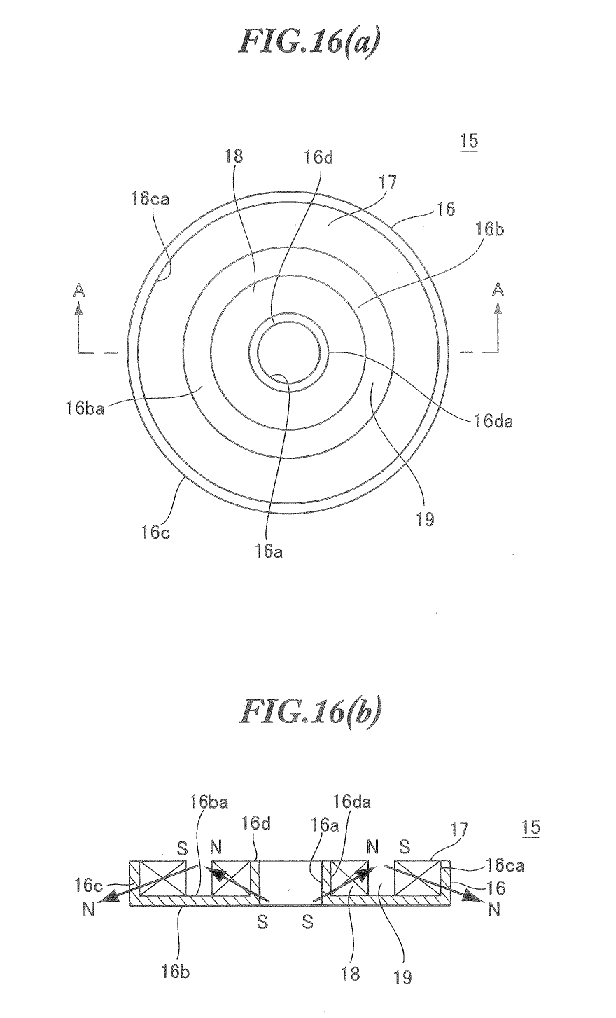

FIG. 16 is a schematic view showing the structure of a speaker magnetic circuit 15 according to embodiment 12 of the present invention, wherein FIG. 16(a) is a plan view and FIG. 16(b) is a sectional view taken along A-A line in FIG. 16(a). The speaker magnetic circuit 15 according to embodiment 12 comprises a yoke 16, an outer magnet 17, and an inner magnet 18. The speaker magnetic circuit 15 has, for example, an outer diameter of about 10 mm and a thickness of about 1.5 mm.

The yoke 16 is made of, for example, a pure iron, an oxygen-free steel, a silicon steel or the like. The whole shape of the yoke 16 is generally circular in a plan view. At a generally central position of the yoke 16 there is formed a through-hole 16a having a generally circular shape. Yoke 16 includes a bottom portion 16b, an outer circumferential side portion 16c, and an inner circumferential side portion 16d, which are formed integrally to form the yoke. The bottom portion 16b is generally annular in shape. The outer circumferential side portion 16c is arranged generally upright on the outer circumference of the bottom portion 16b. On the other hand, the inner circumferential side portion 16d the bottom portion 16b.

The outer magnet 17 and the inner magnet 18 are made of a permanent magnet material such as Nd magnet, Sm—Co magnet, Al—Ni—Co magnet, ferrite magnet or the like. The outer magnet 17 and the inner magnet 18 are each in a generally annular shape. The outer magnet 17 and the inner magnet 18 are each in a thickness substantially equal to a distance from the upper surface 16ba of the bottom portion 16b of the yoke 16 to the upper end of the outer circumferential side portion 16c.

The outer magnet 17 is in contact with the upper surface 16ba of the bottom portion 16b and the inner circumferential surface 16ca of the outer circumferential side portion 16c of the yoke 16, and is fixed to the yoke 16 with an adhesive agent. On the other hand, the inner magnet 18 is in contact with the upper surface 16ba of the bottom portion 16b and the outer circumferential surface 16da of the inner circumferential side portion 16d of the yoke 16, and is fixed to the yoke 16 with an adhesive agent.

A magnetic interval (magnetic gap) 19 is formed between the outer magnet 17 and the inner magnet 18. The outer magnet 17 and the inner magnet 18 are magnetized in an oblique direction with respect to their thickness direction. Specifically, the outer magnet 17, as shown in FIG. 16(b), has S pole on the front side of the speaker device (not shown) including the speaker magnetic circuit 15 (in sound emission direction) and N pole on the rear side of the speaker device (opposite to sound emission direction), and is magnetized at an angle of about 10°-70° with respect to the horizontal direction facing outwardly from the center of the yoke 16. Thus, if the outer magnet 17 is magnetized at an angle of about 10°-70° as described above, the peak of magnetic flux density can be ensured near the position where the voice coil is supported. Moreover, for example, if the outer magnet 17 has S pole on the front side of the speaker device (in sound emission direction) and N pole on the rear side of the speaker device (opposite to sound emission direction), and is magnetized at an angle of about 30°-45° with respect to the horizontal direction facing outwardly from the center of the yoke 16, it is possible to increase the magnetic flux density in the magnetic gap 19.

On the other hand, the inner magnet 18, as shown in FIG. 2(b) for example, has S pole on the rear side of the speaker device (opposite to sound emission direction) and N pole on the front side of the speaker device (in sound emission direction) and is magnetized at an angle of about 10°-70° with respect to the horizontal direction facing outwardly from the center of the yoke 16. Thus, if the inner magnet 18 is magnetized at an angle of about 10°-70° as described above, the peak of the magnetic flux density can be ensured near the position where the voice coil is supported. Moreover, for example, if the inner magnet 18 has S pole on the rear side of the speaker device (opposite to sound emission direction) and N pole on the front side of the speaker device (in sound emission direction) and is magnetized at an angle of about 30°-45° with respect to the horizontal direction facing outwardly from the center of the yoke 16, it is possible to increase the magnetic flux density within the magnetic gap 19.

In this way, with the speaker device including the speaker magnetic circuit 15, it is possible to prevent a decrease of the magnetic flux density within the magnetic gap 19, making it possible to ensure a e great magnetic flux density in the magnetic gap 19.

### Embodiment 13

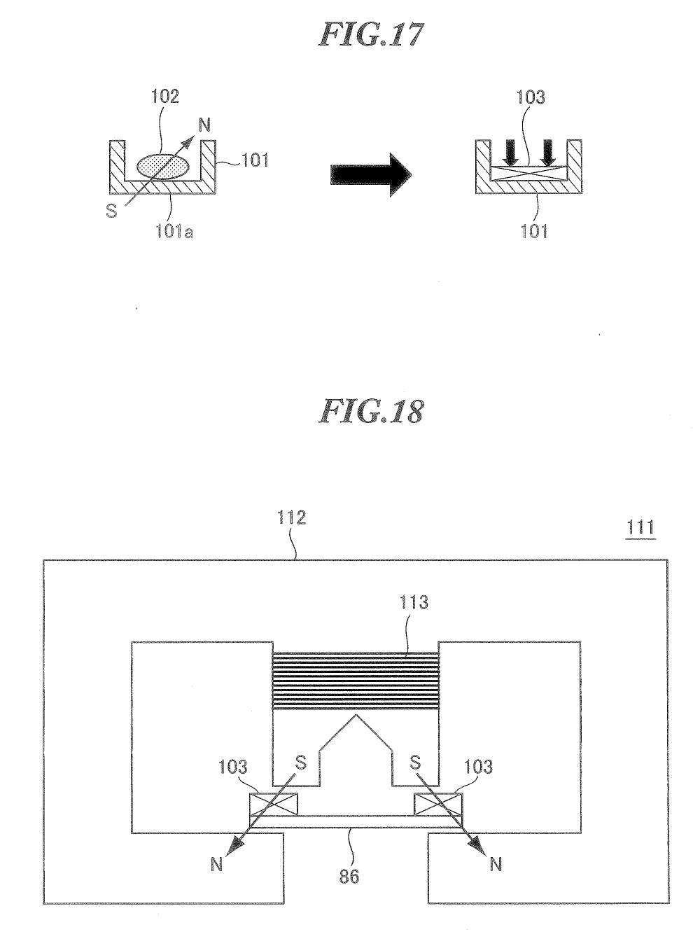

Next, description will be given to explain a method of manufacturing the speaker magnetic circuit 88 according to embodiment 10 of the present invention shown in FIG. 14, with reference to FIG. 17 and FIG. 18.

### (i) Step 1 (Magnet Formation Step)

First, a container 101 as shown in FIG. 17 is fully filled with an amount of magnetic powder (magnetic fluid) 102. At this time, a magnetic field is applied in an oblique and upward direction with respect to the vertical direction (oblique with respect to the thickness direction of a magnet 103 described below) from the bottom 101a of the container 101, as represented by an arrow in FIG. 17. Next, as shown in FIG. 17, a pressure is applied to the magnetic powder (magnetic fluid) to form a magnet (solid) 103. At this moment, it is preferred that the pressure should be applied in a direction generally perpendicular to the magnetic field direction, so as to maximize the magnetic performance of the magnet 103. In this way, the orientation of the magnetic powder (magnetic material) 102 can be determined through the magnet formation step described above.

### (ii) Step 2

The magnet 103 obtained in the above Step 1 is fixed along the outer circumference of the upper surface of the yoke 86 using an adhesive agent, thereby producing a yoke assembly.

(iii) Step 3 (Magnet Magnetizing Step)

Next, description will be given to explain a magnet magnetizing step using a magnetizing apparatus 111 shown in FIG. 17. As shown, the magnetizing apparatus 111 comprises a magnetizing yoke 112 and a magnetizing coil 113. At first, the yoke assembly obtained in the above Step 2 is set in the magnetizing apparatus 111. Then, as shown in FIG. 17, a magnetic field is applied in a direction substantially parallel to a direction of a magnetic orientation of the magnet 103, so as to magnetize the magnet 103, thereby obtaining the outer magnets 71-74. At this point, it will be difficult to successfully magnetize the magnet 103 even if the magnet 103 is to be magnetized by applying a magnetic field in a direction different from the direction of the magnetic orientation of the magnet 103.

### (iv) Step 4

Then, using an adhesive agent, a plate 64 is fixed on a magnet being as an inner magnet 75, thereby producing a plate assembly.

(v) Step 5

Next, the plate assembly obtained in the above Step 4 is set in the magnetizing apparatus. Then, as shown in FIG. 14, a magnetic field is applied in a direction substantially parallel to the thickness direction of the above plate assembly, thereby magnetizing the magnet of the plate assembly, thus obtaining the inner magnet 75.

### (vi) Step 6

Next, the assembly obtained in the above Step 5 is fixed with an adhesive agent or a jig to a generally central position of the yoke 86 in the assembly obtained in the above Step 3, thereby obtaining the speaker magnetic circuit 88 shown in FIG. 14.

In this way, according to the embodiment 13 of the present invention, it is possible to manufacture the speaker magnetic circuit 88 using a simple apparatus through simple steps.

### Embodiment 14

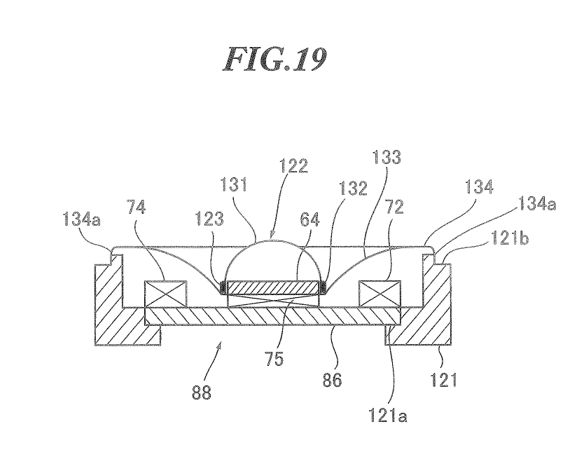

FIG. 19 is a schematic sectional view showing the structure of the speaker device according to embodiment 14 of the present invention. In FIG. 19, parts corresponding to those shown in FIG. 14 are labeled with the same reference numerals as those shown in FIG. 14, with the description thereof omitted. As shown, the speaker device comprises a speaker magnetic circuit 88 according to embodiment 10 of the present invention as shown in FIG. 14, a frame 121, a diaphragm 122, and a voice coil 123.

The frame 121 can be made of a ferrous metal, a non-ferrous metal or their alloy, or a synthetic resin. A ferrous metal can be a pure iron, an oxygen-free steel, a silicon steel or the like. A non-ferrous metal can be aluminum, magnesium, zinc or the like. A synthetic resin can be produced by adding a glass-fiber or a fibrillated thermotropic liquid crystal polyester resin as a reinforcing filler in a thermoplastic resin such as an olefin resin including a polypropylene or the like, an ABS (acrylonitrile butadiene styrene), or a polyethylene terephthalate. Here, the frame 121 can be produced, for example, by squeezing and forming a ferrous metal, or molding and forming non-ferrous metals or their alloy, or injection molding a synthetic resin.

An whole shape of the frame 121 is generally rectangular in a plan view. Specifically, the frame 121 has a stepped engaging portion 121a formed at the upper end on the side of an inner circumference for engaging with an end of the yoke 86, and a stepped engaging portion 121b formed at the upper end on the side of an outer circumference for engaging with an end of the diaphragm 122.

The diaphragm 122 comprises a dome-shaped vibrating part 131, a voice coil bobbin 132, a conical vibrating part 133, and an edge 134. The dome-shaped vibrating part 131, the voice coil bobbin 132, the conical vibrating part 133, and the edge 134 are formed integrally together. The diaphragm 122 can be made of, for example, a paper, a cloth formed of a fiber, a woven fabric, a non-woven fabric, all impregnated with a phenol resin, a silicone resin or a solution containing the resins and an organic solvent. The diaphragm 122 can also be made of a metal material, a synthetic resin, a propylene foamed material or the like. The metal material can be, for example, aluminum, titanium, duralumin, beryllium, magnesium, or their alloy. The synthetic resin can be, for example, a polypropylene, a polyethylene, a polystyrene, a polyethylene terephthalate, a polyethylene naphthalate, a polymethyl methacrylate, a polycarbonate, a polyarylate, an epoxy resin or the like. In addition, the acrylic foamed material can be made from, as a raw material, a methylmethacrylate, a methacrylate, a styrene, an anhydrous maleic acid, or an methacrylamide.

The dome-shaped vibrating part 131 has a shape protruding in the center of the diaphragm 122 on the front side of the speaker device (in sound emission direction). The dome-shaped vibrating part 131 has a longitudinal section formed in a radially curved shape, a semispherical domed shape, a conical shape, a multi-stepped curved shape or the like. In the example shown in FIG. 18, the dome-shaped vibrating part 131 is so formed that its longitudinal section is in a radially curved shape and its central top is higher than the edge 134. With such configuration, it is possible to obtain a broad-angled directional characteristic. The dome-shaped vibrating part 131 can be supported in a predetermined position on the plate 64 with the voice coil bobbin 132, the conical vibrating part 133 and the edge 134, vibratably in the driving direction.

The voice coil bobbin 132 is formed between the dome-shaped vibrating part 131 and the edge 134, and has a generally A-shaped cross-section in the example shown in FIG. 18. On the voice coil bobbin 132, a voice coil 123 formed into an substantially square and tubular shape, falls into a concave part formed between the voice coil bobbin 132 and the conical vibrating part 133, and is fixed with an adhesive agent such as an epoxy resin, or the like.

As shown in FIG. 18, the conical vibrating part 133 is formed from the lower end of the voice coil bobbin 132 to the edge 134 of the diaphragm. 122. Further, the conical vibrating part 133 has a cross section whose generatrix is generally conical. In addition, the conical vibrating part 133 can be formed such that its cross section has a generatrix in a shape which is an arc-curved cone, a flat cone formed in a shape of a straight line, a parabolic cone or the like.

Here, the diaphragm 122 having the above-described structure vibratably supports the voice coil 123 near the end of the plate 64. In addition, as described above, the diaphragm 122 in the concave part located between the voice coil bobbin 132 and the conical vibrating part 133 is formed widely extending from the bottom of the concave part to an upper opening side thereof, thereby the diaphragm 122 is formed easily.

As shown in FIG. 18, the edge 134 has an engaging portion 134a for engaging with the stepped portion 121b of the frame 121. Therefore, it is possible to perform a positioning of the diaphragm 122 with respect to the speaker magnetic circuit 88 and the frame 121 by performing an engagement between the stepped portion 121b of the frame 121 and the engaging portion 134a of the edge 134. In the speaker device described above, the voice coil 123 is supported by the diaphragm 122 at a specified position within a magnetic flux distribution formed with the outer magnets 71-74, the inner magnet 75, the plate 64, and the yoke 86.

When an audio signal (audio current) is supplied to the speaker device having the structure described above, the audio current is supplied through a pair of lead wires (not shown) to the voice coil 123. At this time, the outer magnets 71-74 are magnetized in an oblique direction with respect to their thickness direction, while the inner magnet 75 is magnetized in a direction generally parallel to its thickness direction. Therefore, the magnetic flux generated from the inner magnet 75 flows towards the outer magnets 71-74. As a result, the magnetic flux is collected efficiently at or near the voice coil position where the adequate vibration amplitude of the voice coil 123 can be ensured.

Thus, under an electromagnetic force (Lorentz force) produced by an interaction between the magnetic flux generated from the outer magnets 71-74 and the inner magnet 75 constituting the speaker magnetic circuit 88 on one hand and the audio current flowing to the voice coil 123 on the other, the driving force in the axial direction of the speaker device is induced on the voice coil 123. With the driving force, the voice coil bobbin 132 on which the voice coil is mounted, vibrates in the vertical direction in the drawing, thereby causing the vibrations of the dome-shaped vibrating part 131 and the conical vibrating part 133 accordingly. Under the vibrations of the dome-shaped vibrating part 131 and the conical vibrating part 133, the speaker device emits an acoustic wave corresponding to the audio current to the front space (in sound emission direction), thereby exhibiting two characteristics, with one provided by a dome-shaped speaker device and the other by a cone-shaped speaker device.

As described above, the speaker device according to embodiment 13 of the present invention comprises the speaker magnetic circuit 88, the frame 121, the diaphragm 122, and the voice coil 123. The speaker magnetic circuit 88 comprises the outer magnets 71-74, the inner magnet 75, the plate 64 arranged on one pole side of the inner magnet 75, and the yoke 86 arranged on the other pole side of the inner magnet 75.

The outer magnets 71-74 are magnetized in an oblique direction with respect to their thickness direction. The outer magnets 71-74 are arranged around the inner magnet 75. The inner magnet 75 is magnetized in a direction generally parallel to its thickness direction. In fact, the inner magnet 75 and the plate 64 are stacked on the yoke 86 in an order of at first the inner magnet 75 and then the plate 64.

Further, the diaphragm 122 comprises the dome-shaped vibrating part 131, the voice coil bobbin 132, the conical vibrating part 133, and the edge 134. The diaphragm 122 and the voice coil 123 together form the diaphragm body. In fact, the diaphragm 122 is supported by the frame 121 via the edge 134. The voice coil 123 is mounted near the end of the plate 64 of the speaker magnetic circuit 88. The diaphragm 122 supports vibratably the voice coil 123 near the end of the plate 64.

Therefore, in a speaker device having the above-described structure, since it is possible to prevent a decrease of the magnetic flux density within the magnetic gap 65, it is possible to ensure a great magnetic flux density in the magnetic gap 65. In addition, since the magnetization direction of the outer magnets 72, 74 and other two outer magnets (not shown) is different from the magnetization direction of the inner magnet 75, it is possible to ensure the peak of the magnetic flux density near a position where the voice coil 123 is supported. In addition, even if the speaker device is formed thin in thickness and compact in size, it is still possible to ensure a great magnetic flux density.

The diaphragm 122 comprises: the dome-shaped vibrating part (a first vibrating part) 131 formed on the center of the diaphragm 122; the conical vibrating part (a second vibrating part) 133 having an outer circumference supported by the frame 121 directly or indirectly; and the voice coil bobbin 132 formed between the dome-shaped vibrating part 131 and the conical vibrating part 133, with the voice coil 123 arranged on the voice coil bobbin 132. Since the dome-shaped vibrating part 131, the conical vibrating part 133, and the voice coil bobbin 132 can be formed integrally, by press molding, injection molding or the like, it is possible to easily obtain the diaphragm 122.

The diaphragm 122 has an engaging portion 134a formed at the end of the diaphragm 122 for engaging with the stepped portion 121b (to be embedded) formed on the frame 121. As the diaphragm 122 and the frame 121 engage between the stepped portion 121b of the frame 121 and the engaging portion 134a of the diaphragm 122 and are positioned, it is easy to position the diaphragm 122 and the frame 121.

Thus, since the dome-shaped vibrating part 131, the voice coil bobbin 132, and the conical vibrating part 133 are formed integrally, it becomes possible to highly accurately put the respective essential elements in the predetermined positions. In particular, according to the above structure and an easy attachment step, it is possible to highly accurately put the voice coil bobbin 132 at the predetermined position near the end of the plate 64.

Moreover, an effective vibration area can be increased and thus the sound pressure can be increased simply by fixing the inner side surface of the end of the diaphragm 122 to the outer side surface of the stepped portion 121b of the frame 121. In addition, the voice coil 123 can be easily attached on the voice coil bobbin 132 by fixing the voice coil 123 to the side face part of the L-shaped cross section part of the voice coil bobbin 132 with an adhesive agent.

While the above description has been given in detail to explain the embodiments of the present invention with reference to the accompanying drawings, the detailed constitutions should not be limited to those embodiments. In fact, various variations and modifications can be included in the present invention without departing from the gist of the invention.

For example, though the above-discussed embodiment 1 shows an example in which the diaphragm 32 has a conical longitudinal cross sectional shape, the present invention is not limited to this. For example, the diaphragm 32 can have the longitudinal cross section to be generally dome-shaped, protruding to the front side (sound wave emission side) of speaker device.

Further, though the above-discussed embodiment 4 shows an example in which the voice coil 123 is mounted on the inner side of the voice coil bobbin 132, the present invention is not limited to this. For example, it is also possible for the voice coil 123 to be attached on the outside of the voice coil bobbin 132.

Moreover, as to the above-discussed embodiment 14, it is also possible to provide a magnetic fluid between the plate 64 and the voice coil bobbin 132 or the voice coil 123. If the magnetic fluid is arranged in such a manner, it is possible to increase the electromagnetic force acting on the voice coil 123, and to transfer the heat (Joule heat) produced on the voice coil 123 to the plate 64 and then dissipate the same.

In the embodiments described above, the polarities of the magnets are in directions indicated by the arrows shown in FIG. 2(b), FIG. 5-FIG. 10, FIG. 11(b), FIG. 12-FIG. 15, and FIG. 16(b). However, the present invention is not limited to this. For example, it is also possible for the polarities to be in directions opposite to those arrows shown in the drawings.

In addition, the above-discussed various embodiments are applicable to one another, provided that there are no contradictions in their objects and constitutions.

1-17. (canceled)

18. A speaker magnetic circuit comprising a magnet and a yoke, wherein
a magnetic orientation of the magnet is in an oblique direction with respect to the thickness direction of the magnet, the magnetic orientations in said magnet are substantially the similar in said thickness direction,
a magnetic flux generated from the magnet passes through a position separated from an upper surface of the yoke and being on the side of the magnet.

19. The speaker magnetic circuit according to claim 18, comprising a plurality of magnets including said magnet and a plate, wherein
among an inner magnet and an outer magnet included in the plurality of magnets, the plate is arranged on one of the magnets and the other of the magnets is said magnet,
a magnetic orientation of the one of the magnets is in its thickness direction and a magnetic orientation of the other of the magnets is in an oblique direction with respect to its thickness direction,
the magnetic orientations in the other of the magnets are substantially the similar in said thickness direction,
a magnetic gap arranged between said plate and the other of the magnets is on side of said plate or the other of the magnets with respect to a bottom portion of the yoke, and located in a position separated from the bottom portion of the yoke.

20. The speaker magnetic circuit according to claim 19, wherein an outer side surface and an inner side surface of the inner magnet and the outer magnet extend in a direction substantially perpendicular to said yoke.

21. The speaker magnetic circuit according to claim 20, wherein the bottom portion of the yoke has a tabular shape.

22. The speaker magnetic circuit according to claim 21, wherein a lower surface of the outer magnet connects to the yoke, from an inner side surface to an outer side surface of the outer magnet.

23. The speaker magnetic circuit according to claim 22, wherein the inner magnet has a planar surface defined by a long axis and a short axis, a plurality of rod-like magnets serving as the outer magnet are arranged along the long axis or the short axis of the inner magnet and the inner magnet is arranged between the outer magnets.

24. The speaker magnetic circuit according to claim 23, wherein the upper surface of the outer magnet is located at a lower position with respect to the upper surface of the plate.

25. The speaker magnetic circuit according to claim 24, wherein a peak position of the magnetic flux density within the magnet gap is near a height at which the upper surface of the plate is arranged.

26. A speaker device comprising: a speaker magnetic circuit according to claim 25;
a frame; and a diaphragm body,
wherein
the diaphragm body includes a diaphragm and a tubular voice coil supported by the diaphragm,
a lower end of the voice coil is located at a lower position with respect to the upper surface of the plate,
a central position of the voice coil is located at a position which is substantially the same as or lower than the upper surface of the plate,
a magnet gap is arranged at a position where the voice coil is arranged.

27. The speaker device according to claim 26, wherein the peak position of the magnetic flux density within the magnetic gap is near the central position of the voice coil.

28. The speaker device according to claim 27, wherein the diaphragm body has an edge for supporting the diaphragm on the frame, wherein
the diaphragm has a dome-like shape or a tabular shape,
the diaphragm body or the speaker magnetic circuit has a planar shape defined by a short axis and a long axis.

29. The speaker magnetic circuit according to claim 18, comprising an outer magnet and an inner magnet serving as said magnet, wherein
a magnetic orientation of the inner magnet and a magnetic orientation of the outer magnet are in an oblique direction with respect to the thickness direction of the magnets, the magnetic orientations in the inner and outer magnets are substantially the same in the thickness direction of the inner and outer magnets,
a magnetic gap arranged between the inner and outer magnets is on side of the inner magnet or the outer magnet with respect to the yoke, and located in a position separated from the yoke.

30. The speaker magnetic circuit according to claim 29, wherein inner and outer side surfaces of the inner and outer magnets extend in a direction substantially perpendicular to a surface of the yoke facing the bottom surfaces of the inner and outer magnets.

31. The speaker magnetic circuit according to claim 30, wherein
the yoke includes a tabular bottom portion and an outer circumferential side portion surrounding the bottom portion,
the inner and outer magnets connect to the outer circumferential side portion of the yoke,
a predetermined gap is provided between the bottom surfaces of the inner and outer magnets on one hand and the yoke on the other.

32. The speaker magnetic circuit according to claim 31, wherein the bottom portion of the yoke to which the bottom surfaces of the inner and outer magnets connect, has a tabular shape.

33. The speaker magnetic circuit according to claim 32, wherein
the position of a upper surface of the inner magnet is substantially the same as that of the outer magnet,
the magnetic gap is arranged near the positions of the upper surfaces of the inner and outer magnets.

34. The speaker magnetic circuit according to claim 33, wherein
the upper surface of the inner magnet is at a higher position with respect to the upper surface of the outer magnet,
the magnetic gap is arranged near the position of the upper surface of the inner magnet.

35. The speaker magnetic circuit according to claim 34, wherein the upper surface of the outer magnet is at a higher position with respect to the upper surface of the inner magnet, the magnetic gap is arranged near the position of the upper surface of the outer magnet.

36. The speaker magnetic circuit according to claim 35, wherein the outer diameter of the outer magnet is substantially the same as the outer diameter of the bottom portion of the yoke.

37. The speaker magnetic circuit according to claim 18, wherein the yoke has a tabular bottom portion to which the lower surface of said magnet connect, and a side portion facing the inner or outer side surface of the magnet,
a magnetic gap arranged between the magnet and the side portion of the yoke is on the side of the magnet with respect to the yoke, and located in a position separated from the yoke.

38. The speaker magnetic circuit according to claim 18, comprising a plurality of magnets including said magnet and a plate, wherein
among an inner magnet and an outer magnet included in the plurality of magnets, the plate is arranged on one of the magnets and the other of the magnets is said magnet,
a magnetic orientation of one of the magnets is in its thickness direction and a magnetic orientation of the other of the magnets is in an oblique direction with respect to its thickness direction,
magnetic orientations in the other of the magnets are substantially the same in said thickness direction,
a magnetic gap arranged between said plate and the other of the magnets is on side of said plate or the other of the magnets with respect to the yoke, and located in a position separated from the yoke.

39. The speaker magnetic circuit according to claim 38, wherein
a position of a upper surface of the plate is substantially the same as a position of the upper surface of the other of the magnets,
the magnetic gap is arranged near the position of the upper surfaces of the plate and the other of the magnets.

40. A speaker device comprising a speaker magnetic circuit according to claim 18, a frame, and a diaphragm body, wherein
the speaker magnetic circuit has a plurality of magnets including said magnet and a plate,
a plate is arranged on an inner magnet included in the plurality of magnets, an outer magnet is said magnet,
a magnetic orientation of the inner magnet is in its thickness direction
a magnetic orientation of an outer magnet is in an oblique direction with respect to its thickness direction,
magnetic orientations in the outer magnets are substantially the same in said thickness direction,
the diaphragm body includes a diaphragm, an edge for supporting the diaphragm on the frame, and a voice coil supported by the diaphragm,
the diaphragm supports vibratably the voice coil near an outer end of the plate.

41. The speaker device according to claim 40, wherein
the diaphragm has a conical shape, a dome-like shape, or a tabular shape,
the diaphragm has a voice coil housing part for housing the voice coil,
an outer circumferential portion of the edge connects to a stepped portion arranged on an outer circumferential portion of the frame.

42. An electronic apparatus including a speaker device according to claim 26.

43. A method of manufacturing a speaker magnetic circuit including a yoke and a magnet,
wherein the speaker magnetic circuit is so formed that a magnetic orientation of the magnet is in an oblique direction with respect to its thickness direction, the magnetic orientations in the magnet are substantially the same in its thickness direction,
the method comprises:
a magnetizing step for applying a magnetic field including a predetermined direction to the magnet; and
a magnet fixing step for fixing the magnet on the yoke;
wherein a magnetic flux generated from the magnet passes through a position separated from the upper surface of the yoke and being on the side of the magnet.

44. A method of manufacturing a speaker magnetic circuit according to claim 43, comprising a magnet formation step for applying a pressing force to a magnetic powder in a magnetic field having a predetermined direction,
wherein said predetermined direction is oblique with respect to the thickness direction of the magnet.
